(19) United States
(12) Patent Application Publication
(10) Pub. No.: US 2017/0026366 A1
(43) Pub. Date: Jan. 26, 2017

(54) Providing a virtual connection for transmitting application data units

(71) Applicants: Jian Wang, Chengdu (CN); Martin Becker, Lauf an der Pegnitz (DE)

(72) Inventors: Jian Wang, Chengdu (CN); Martin Becker, Lauf an der Pegnitz (DE)

(73) Assignee: certgate GmbH, Nürnberg (DE)

(21) Appl. No.: 15/287,942

(22) Filed: Oct. 7, 2016

Related U.S. Application Data
(63) Continuation of application No. PCT/EP2015/056494, filed on Mar. 26, 2015.

(30) Foreign Application Priority Data
Apr. 7, 2014 (DE) 10 2014 004 917.5

(51) Int. Cl. H04L 29/06

(52) U.S. Cl. CPC H04L 63/0853; H04L 67/42; H04L 63/0428

(57) ABSTRACT

Method, comprising authenticating one or more first clients by a server, authenticating one or more second clients by the server and providing at least one application data unit switching by the server such that, when a data packet having a control application data unit is received from one of the first clients at the server, the server sends a data packet having the control application data unit that the received data packet contains to at least one of the second clients, and/or that, when a data packet having a response application data unit is received from one of the second clients at the server, the server sends a data packet having the response application data unit that the received data packet contains to at least one of the first clients.

### CROSS-REFERENCE TO RELATED PATENT APPLICATIONS

This patent application is a continuation of PCT/EP2015/056494, filed Mar. 26, 2015, which claims priority to German Application No. 10 2014 004 917.5, filed Apr. 7, 2014, the entire teachings and disclosure of which are incorporated herein by reference thereto.

### FIELD OF THE INVENTION

The invention relates, inter alia, to a method for providing a virtual connection for transmitting application data units.

### BACKGROUND TO THE INVENTION

In the state of the art, methods are known for establishing a direct connection between a first data processing system and a chip card connected to a second data processing system. Depending on the network configuration, however, such direct connections between a first data processing system and a second data processing system may not be possible, for example, if a configuration of a firewall prevents such a direct connection. Furthermore, access to a number of chip cards via such direct connections is very complex, as a direct connection must be established for each individual chip card.

### SUMMARY OF A NUMBER OF EXEMPLARY EMBODIMENTS OF THE INVENTION

An object of the invention is therefore to overcome the abovementioned disadvantages.

This object is achieved by the subject matter of the main claim and the sub-claims. Advantageous exemplary embodiments of the invention are presented in the sub-claims.

A first method according to the invention comprises authenticating one or more first clients by a server, authenticating one or more second clients by the server, and providing at least one application data unit switching by the server such that, when a data packet having a control application data unit is received from one of the first clients at the server, the server sends a data packet having the control application data unit that the received data packet contains to at least one of the second clients, and/or that, when a data packet having a response application data unit is received from one of the second clients at the server, the server sends a data packet having the response application data unit that the received data packet contains to at least one of the first clients.

A second method according to the invention comprises authenticating a first client by the first client with respect to a server, and sending a data packet with a control application data unit from the first client to the server and/or receiving a data packet with a response application data unit from the server to the first client.

A third method according to the invention comprises authenticating a second client by the second client with respect to a server, and receiving a data packet with a control application data unit from the server to the second client and/or sending a data packet with a response application data unit from the second client to the server.

A fourth method according to the invention for providing a virtual connection for transmitting application data unit comprises the steps of the first method according to the invention, which, for example, are performed on a server, the steps of the second method according to the invention, which, for example, are performed on a first client, and the steps of the third method according to the invention, which, for example, are performed on a second client. The steps of the first, of the second and of the third method according to the invention are thus intended to preferably be understood as corresponding steps of the fourth method according to the invention for providing a virtual connection for transmitting application data units, able by way of example to be performed in a system, comprising the server, the first client and the second client.

For example, the methods according to the invention each relate to the same server, the same first clients and the same second clients. The first client of the second method according to the invention is, for example, one of these first clients, and the second client of the third method according to the invention is, for example, one of these second clients. The first clients, the second clients and the server are, for example, mutually different data processing systems. The server is preferably a server device according to the invention. Furthermore, each of the first clients is preferably in each case a first client according to the invention, and each of the second clients is preferably in each case a second client according to the invention.

In the following disclosure in most cases reference is made to a plurality of first and a plurality of second clients. This disclosure represents merely a simplification and is not intended to be understood as a limitation. The disclosure of a multiplicity of clients is accordingly intended—to the extent that this is meaningful—to always also be understood as the disclosure of an individual client.

The server is, for example, connected to the first clients and the second clients. For example, the server is connected to the first clients and the second clients via one or a plurality of networks. Examples of a network are a Local Area Network (LAN) such as an Ethernet network or an IEEE 802 network, a Wide Area Network (WAN), a Global Area Network (GAN), a wireless network, a wired network, a mobile network, a telephone network and/or the Internet. For example, the server is at least partially connected via the Internet with the first clients and the second clients.

The connection between the server and the first clients and the second clients can be connectionless or connection oriented. Between each of the clients and the server, for example, there is in each case a network connection.

For example, there is no direct connection between the first and the second clients. For example, the first clients and/or the second clients are part of a network or a plurality of networks. For example, the first clients and/or the second clients are at least partially in each case connected via a firewall (e.g. a software firewall and/or a hardware firewall) and/or a router to the Internet. For example, the firewall and/or the router prevents a direct network connection between the first clients and the second clients.

A server is intended in particular to be understood as a data processing system equipped with software and/or hardware, allowing it to provide other data processing systems with a service such as an application data unit switching. A client is intended in particular to be understood to be a data processing system equipped with software and/or hardware, allowing it to use a service provided by a server such as an application data unit switching.

For example, the first clients and the second clients authenticate themselves with respect to the server in each case with at least one command, comprising the information necessary for authentication (e.g. a user name and a password). Authenticating the first clients with respect to the server is intended, for example, to be understood as the first clients in each case logging on to the server. Authenticating the second clients with respect to the server is intended, for example, to be understood as the second clients in each case logging on to the server. By way of example, the first clients and/or the second clients log on to the server, in order to use the application data unit switching provided by the server. For example, only clients logged on to the server may use the application data unit switching. For example, the first clients and/or the second clients send logon information to the server (e.g. via a respective network connection). For example, the first clients and/or the second clients send the logon information as a command to the server (e.g. via a respective network connection). The logon information is, for example, customised for each of the clients or a group of clients. It is also conceivable, however, for the logon information to be the same for all clients. For example, the logon information comprises a unique identifier such as a user name (e.g. an e-mail address, a customer number or a registration number), a password, an authentication feature, a biometric feature and/or a unique identifier of the respective client (e.g. a Media Access Control address or an International Mobile Subscriber Identity).

The logon information can at least partially be entered by a user on the first and/or second clients and/or at least partially read-in by the first and/or second clients. For example, a user can in each case enter a user name and a password on the first and/or second clients as logon information. For example, the first and/or second clients can in each case read in an authentication feature from a security token such as a chip card connected to the respective client and/or a biometric feature of a user as logon information.

Authenticating the first clients and the second clients by the server is intended, for example, to be understood as the server checking if the first clients and the second clients are authorised to log on to the server. For example, the server checks whether the first clients and/or the second clients in each case are authorised to use the application data unit switching provided by the server. For example, only clients authenticated by the server and/or logged on to the server, may use the application data unit switching provided by the server.

For example, the server has access to appropriate authorisation information. For example, the authorisation information comprises information corresponding to the logon information, for example, a unique identifier such as a user name (e.g. an e-mail address, a customer number or a registration number), a password, an authentication feature, a biometric feature and/or a unique identifier of the respective client (e.g. a Media Access Control address or an International Mobile Subscriber Identity). Furthermore, the authorisation information can comprise information on whether the respective client is authorised to use the at least one application data unit switching.

The authorisation information can be stored in a database such as, for example, a directory service. For example, the authorisation information is stored in a memory of the server. For example, the authorisation information is stored in a memory outside of the server, which the server is able to access (e.g. in a memory of a database server which the server is able to access via a network).

Thus, various possibilities for authenticating the first clients and of the second clients by the server are conceivable. For example, one or more access control means of the server can be established to authenticate the first clients and the second clients. For example, the access control means are interchangeable. The access control means can be in the form of software and/or hardware. For example, the access control means comprise at least one processor and at least one memory with program instructions, wherein the at least one memory and the program instructions are configured so that, together with the at least one processor, they cause the server to authenticate the first clients and the second clients. For example, the access control means can be in the form of an access control module (ACM) which, for example, can be exchanged on the server using the plug-in concept. This is, for example, advantageous, to allow simple exchange of the access control module and thus uncomplicated adaptation of the authentication of the first clients and of the second clients by the server, without, for example, the programming of the server (e.g. a server program) having to be completely changed. For example, no change to the programming of the server (e.g. of a server program) is necessary at all when the access control module is exchanged. For example, in the access control module and/or in the access control means a database with authorisation information can be stored (e.g. the access control module comprises such a database). It is, for example, also conceivable, for an access control module and/or an access control means to have access to a directory service with authorisation information (e.g. access to a directory service with authorisation information, provided by a database server distinct from the server).

For example, the server receives from each of the first clients and from each of the second clients corresponding logon information. For example, the server receives from each of the first clients and from each of the second clients corresponding logon information via respective network connections with the client. The server can then authenticate the respective clients in each case by comparing the respective logon information with the respective authorisation information.

Sending a data packet (or information) from a client to the server is intended to be understood, for example, as the client sending the data packet (or the information) so that it can be received at the server. Sending a data packet (or information) from the server to one or a plurality of clients is intended to be understood, for example, as the server sending the data packet (or the information) so that it can be received at the client or clients. Preferably, a data packet (or information) is sent so that it is transmitted via a network connection.

Receiving a data packet (or information) at the server or at a client is intended, for example, to be understood as the data packet (or the information) being received at the server or at the client. Preferably a data packet (or information) is received so that it is obtained via a network connection.

A data packet is, for example, a data unit, with a specified length and/or form. A data packet is, for example, a data unit, transmitted in a network with a packet-switched transmission protocol. For example, a data packet contains a header data field and a user data field. For example, a data packet, in addition to the actual user data, also contains header data with administrative information and addressing information. The header data are, for example, contained in the header data field (that is to say, the header) of the data packet. A data packet with an application data unit contains the application data unit, for example, as user data (that is to say that the application data unit is transmitted in a user data field of the data packet).

An application data unit is, for example, a data unit, with a specified length and/or form. By way of example, application data units are exchanged between a chip card application, executed by a processor of a data processing system, and a chip card (e.g. directly) connected to the data processing system, in order to access the chip card.

Providing at least one application data unit switching by the server is intended, for example, to be understood as the server providing a service for at least one application data unit switching. The at least one application data unit switching provided by a server conveys, for example, control application data units, contained in data packets received at the server from the first clients, to the second clients and response application data units, contained in data packets received from the second clients at the server, to the first clients. The transmission of the application data units between the first clients, the server and the second clients in each case takes place in data packets.

The at least one data unit switching provided by the server is, for example, established so that when a data packet with a control application data unit is received from one of the first clients at the server, the server sends a data packet with the control application data unit that the received data packet contains to at least one of the second clients (for example, at least partially according to a mapping between the first and second clients). For example, the server unpacks the control application data unit from the received data packet and inserts it in a data packet to be sent (or a plurality of data packets to be sent). It is also conceivable, however, for the received data packet and the data packet to be sent (or the plurality of data packets to be sent) to be identical.

The at least one application data unit switching provided by the server is alternatively or additionally, for example, established so that when a data packet with a response application data unit from one of the second clients is received at the server, the server sends a data packet with the response application data unit that the received data packet contains to at least one of the first clients (for example, at least partially according to a mapping between the first and second clients). For example, the server unpacks the response application data unit from the received data packet and inserts it in a data packet to be sent (or a plurality of data packets to be sent). It is also conceivable, however, for the received data packet and the data packet to be sent (or the plurality of data packets to be sent) to be identical.

For example, the at least one application data unit switching provided by the server is established so that an application data unit received at the server (thus an application data unit that a received data packet contains) is conveyed according to a mapping (e.g. a specified mapping) between the first clients and the second clients and/or a mapping of the application data unit, to at least one of the first and/or second clients. In this connection, switching is intended to be understood as, for example, passing on and/or sending (e.g. forwarding). Through such a mapping, therefore, it is possible to determine which clients are intended to receive an application data unit and/or to which clients the server is intended to send (e.g. forward) a data packet with an application data unit

For example, this mapping is at least partially specified by mapping information in the received application data unit and/or in the received data packet that the application data unit contains, so that for each application data unit a different mapping can be specified. For example, the mapping information contains a unique identifier (e.g. a user name) for each client, which is intended to receive the application data. For example, the at least one application data unit switching provided by the server, is established to convey an application data unit received at the server (thus an application data unit that a received data packet contains) to each client, the unique identifier of which is contained in the mapping information. For example, the server knows the unique identifier of all clients logged on to the server. By way of example, the unique identifier (e.g. a username) of a client is contained in the logon information of the client.

For example, this mapping is alternatively or additionally at least partially stored in mapping information in a database. For example, the mapping information is stored in a memory of the server. For example, the mapping information is stored in a memory outside of the server, which the server is able to access via a network connection (e.g. in a memory of a database server different from the server, providing a directory service).

An example of a mapping is, for example, a mapping between one first client and a plurality of second clients (referred to as a 1:n mapping), so that the server conveys all control application data units from the one first client to the plurality of second clients and all response application data units from the plurality of second clients to the one first client. A further example of a mapping is, for example, a mapping between a plurality of first clients and one second client (referred to as a n:1 mapping), so that the server conveys all control application data units from the plurality of first clients to the one second client and all response application data units from the one second client to the plurality of first clients. A further example of a mapping is, for example, a mapping between one first client and one second client (referred to as 1:1 mapping), so that the server conveys all response application data units from the one second client to the one first client and all control application data units from the one first client to the one second client. A further example of a mapping is, for example, a mapping between a plurality of first clients and a plurality of second clients (referred to as n:n mapping), so that the server conveys all response application data units from the plurality of second clients to the plurality of first clients and all control application data units from the plurality of first clients to the plurality of second clients.

For example, one or more application data unit switching means of the server can be established to provide the application data unit switching. For example, the application data unit switching means are interchangeable. The application data unit switching means can be in the form of software and/or hardware. For example, the application data unit switching means comprise at least one processor and at least one memory with program instructions, wherein the at least one memory and the program instructions are configured so that, together with the at least one processor, they cause the server to provide the at least one application data unit switching. For example, the application data unit switching means are in the form of an application data unit switching module which, for example, can be exchanged on the server using the plug-in concept.

A server according to the invention comprises one or a plurality of means for carrying out the steps of the first method according to the invention (e.g. an access control means and/or an application data unit switching means). A first client according to the invention comprises one or a plurality of means for carrying out the steps of the second method according to the invention. A second client according to the invention comprises one or a plurality of means for carrying out the steps of the third method according to the invention.

For example, the server according to the invention, the first client according to the invention and the second client according to the invention are data processing systems that are different from another, established as software and/or hardware to be able to carry out the respective steps of the respective method according to the invention. Established as software and/or hardware is intended to be understood as, for example, the preparation of the respective data processing system, necessary to carry out the steps of a respective method, for example, in the form of a computer program. Examples of a data processing system are a computer, a desktop computer, a portable computer such as a laptop computer, a tablet computer, a Personal Digital Assistant, a Smartphone, a smartcard terminal and/or a thin client.

For example, the server according to the invention, the first client according to the invention and/or the second client according to the invention in each case comprise means for executing one of the computer programs according to the invention such as a processor. A processor is intended to be understood as, for example, a control unit, a microprocessor, a micro-control unit such as a microcontroller, a digital signal processor (DSP), an Application Specific Integrated Circuit (ASIC) or a Field Programmable Gate Array (FPGA).

For example, the server according to the invention, the first client according to the invention and/or the second client according to the invention further comprise in each case means for storing data and/or information such as a program memory and/or a main memory.

For example, the server according to the invention, the first client according to the invention and/or the second client according to the invention further comprise in each case means for receiving and/or sending data and/or information via a network such as a network interface or a network card. For example, the server according to the invention, the first client according to the invention and the second client according to the invention are connected or connectable to each other via one or a plurality of networks.

For example, the server according to the invention comprises at least one processor and at least one memory with program instructions, wherein the at least one memory and the program instructions are configured so that, together with the at least one processor, they cause the server according to the invention to carry out the steps of the first method according to the invention. For example, first client according to the invention comprises at least one processor and at least one memory with program instructions, wherein the at least one memory and the program instructions are configured so that, together with the at least one processor, they cause the first client according to the invention to carry out the steps of the second method according to the invention. For example, second client according to the invention comprises at least one processor and at least one memory with program instructions, wherein the at least one memory and the program instructions are configured so that, together with the at least one processor, they cause the second client according to the invention to carry out the steps of the third method according to the invention.

A system according to the invention for providing a virtual connection for transmitting application data units comprises (at least) one server according to the invention, (at least) one first client according to the invention and (at least) one second client according to the invention.

The computer programs according to the invention comprise program instructions, which cause a data processing system to carry out at least one of the methods according to the invention, when one of the computer programs according to the invention is executed on a processor of the data processing system. A computer program is, for example, distributable via a network. A computer program can at least partially be software and/or firmware of a processor. A computer program according to the invention can also, for example, be made up of a plurality of programs and/or applications or interact with further programs and/or applications, to cause a data processing system to carry out a method according to the invention.

The computer program according to the invention, that comprises program instructions that cause a data processing system to carry out the first method according to the invention, when the computer program according to the invention is executed on a processor of the data processing system is, for example, in the form of a server program.

The computer program according to the invention, that comprises program instructions that cause a data processing system to carry out the second method according to the invention, when the computer program according to the invention is executed on a processor of the data processing system, is, for example, at least partially in the form of a client program. For example, the client program provides other applications, that are executed by a processor of the data processing system, with an interface for accessing a chip card via the application data unit switching provided by a server. For example, the interface is a virtual device driver for a chip card access unit (e.g. a virtual PC/SC device driver) and/or a programming interface (API, Application Programming Interface). For example, the client program is part of the operating system layer of the data processing system, when it is executed on the processor of the data processing system, and provides other computer programs of the application layer of the data processing system with an interface (e.g. a programming interface) for accessing a chip card via the application data unit switching provided by a server. For example, a chip card application, executed by a processor of the data processing system, uses the interface in order to access a chip card via the application data unit switching provided by the server. This is, for example, advantageous since for the chip card applications there is no difference from accessing a chip card connected directly with the data processing system. Thus existing chip card applications on a chip card can access the application data unit switching provided by the server.

The computer program according to the invention, that comprises program instructions that cause a data processing system to carry out the third method according to the invention, when the computer program according to the invention is executed on a processor of the data processing system, is, for example, in the form of an agent program. For example, the agent program interacts with a device driver program for a chip card access unit, to enable access to a chip card connected to the data processing system via the application data unit switching provided by the server. For example, the device driver program for the chip card access unit provides other computer programs such as a chip card application or the agent program, executed by a processor of the data processing system, with an interface (e.g. a programming interface) for accessing a chip card via a chip card access unit, when the device driver program for the chip card access unit is executed on a processor of the data processing system. For example, the device driver program for the chip card access unit is part of the operating system layer of the data processing system, when it is executed on the processor of the data processing system, and provides other computer programs of the application layer of the data processing system with an interface (e.g. a programming interface) for accessing a chip card via the chip card access unit with application data units.

The computer programs according to the invention can in each case be stored in a machine-readable storage medium, containing one or a plurality of computer programs according to the invention and is, for example, in the form of a magnetic, electrical, electro-magnetic, optical and/or other type of storage medium. Such a machine-readable storage medium is preferably physical (thus “tangible”), for example, it is in the form of a data carrier device. Such a data carrier device is, for example, portable or permanently installed in a device. Examples of such a carrier device are a volatile or non-volatile memory with random access (RAM) such as, for example, a NOR flash memory or with sequential access such as a NAN O-flash memory and/or memory with read-only access (ROM) or write-only access. Machine-readable is intended, for example, to be understood as the storage medium being able to read (out) and/or be written to by a computer or a data processing system, for example, by a processor.

Through the fourth method according to the invention, therefore, a virtual connection is provided, via which between the first clients and the second clients (or with chip cards attached to the second clients) via the at least one application data unit switching provided by the server, application data units can be particularly simply and flexibly transmitted.

This is, for example, advantageous to enable remote access to a chip card. Via the application data unit switching (i.e. the virtual connection) a client can, for example, access a client on a chip card connected to another client. For example, a chip card application, executed by a processor of a first client, via the virtual connection, can exchange application data units with a chip card directly connected to a second client, in order to access the chip card. Here, on the basis of the authentication of the clients by the server it can be ensured that only trustworthy clients can transmit application data units via the virtual connection. Furthermore, changes such as the addition or removal of clients to or from the system according to the invention can be carried out particularly simply and quickly, since with such changes only the application data unit switching of the server (or the mapping) has to be adapted, but no changes to the clients are necessary.

This is further advantageous, for example, in order to reduce the number of data packets to be sent by the clients. For example, a first client can send an application data unit to a plurality of second clients, without it having to send a data packet with the application data unit to the server for each of the second clients. Instead, it is sufficient if the second clients are assigned to the first client, so that the first client sends a single data packet with an application data unit to the server. Furthermore, application data units can also be transmitted between clients, which do not even know the address of the respective other client.

Furthermore, this is, for example, advantageous in order to reduce the effort on administration of the connections with the clients. For example, the clients only have to authenticate themselves with respect to the server or be authenticated by the server once, and can, despite this, exchange application data units with various clients.

In the following, exemplary embodiments of the invention are described, based on further exemplary features of the method according to the invention, the computer programs according to the invention, the servers according to the invention, the first clients according to the invention, the second clients according to the invention and the systems according to the invention. In particular, through the description of an additional method step of a method according to the invention the intention is for the following to be considered disclosed: means for carrying out the method step of the server according to the invention, of the first client according to the invention or of the second client according to the invention and a corresponding program instruction of the computer program according to the invention which causes a data processing system to carry out the method step, when the computer program is executed by a processor of the data processing system. The same is intended to apply to the disclosure of a means for carrying out a method step or a program instruction, for example, the disclosure of a means for carrying out a method step is also intended to be understood as a disclosure of the corresponding method step and the corresponding program instruction.

In exemplary embodiments of the invention the first method according to the invention further comprises receiving a data packet with a control application data unit from one of the first clients at the server, and sending a data packet with the control application data unit that the received data packet contains, from the server to at least one of the second clients. For example, the server sends the data packet at least partially according to a specified mapping between the first and second clients to at least one of the second clients.

In exemplary embodiments of the invention the first method according to the invention further comprises receiving a data packet with a response application data unit from one of the second clients at the server, and sending a data packet with the response application data unit that the received data packet contains from the server to at least one of the first clients. For example, the server sends the data packet at least partially according to a specified mapping between the first and second clients to at least one of the first clients.

In exemplary embodiments of the first method according to the invention the first clients and the second clients are authenticated by the server for the at least one application data unit switching, and in exemplary embodiments of the second method according to the invention the first client authenticates itself for an application data unit switching to one or a plurality of second clients with respect to the server, and in exemplary embodiments of the third method according to the invention the second client authenticates itself for an application data unit switching to one or a plurality of first clients with respect to the server.

Authenticating the first clients for an application data unit switching to one or a plurality of second clients with respect to the server is, for example, intended to be understood as the first clients in each case logging on to the server to use the at least one application data unit switching. Authenticating the second clients for an application data unit switching to one or a plurality of first clients with respect to the server is intended to be understood, for example, as the second clients in each case logging on to the server to use the at least one application data unit switching. For example, only clients logged on to the server for the at least one application data unit switching may use the at least one application data unit switching. For example, the first clients and/or the second clients send logon information for the at least one application data unit switching to the server (e.g. via respective network connections).

Authenticating the first clients and the second clients for the at least one application data unit switching by the server is intended, for example, to be understood as the server checking whether the first clients and the second clients are authorised to log on for the at least one application data unit switching. By way of example, the server checks whether the first clients and/or the second clients in each case are authorised to use the at least one application data unit switching provided by the server. For example, it can be provided that for each use of an application data unit switching provided by the server a separate logon to the server is necessary. It is also conceivable, however, for just one logon to be necessary. By way of example, only clients authenticated by the server for the at least one application data unit switching and/or logged on for the at least one application data unit switching on the server, may use the at least one application data unit switching provided by the server.

By way of example, the server provides the at least one application data unit switching so that only when a data packet having a control application data unit from a first client authenticated for the at least one application data unit switching is received at the server, does the server send a data packet with the control application data unit that the received data packet contains to at least one of the second clients authenticated for this application data unit switching at least partially according to a specified mapping between the first clients and the second clients, and/or that, only when a data packet having a response application data unit is received from a second client authenticated for the at least one application data unit switching at the server, does the server send a data packet with the response application data unit that the received data packet contains to at least one of the first clients authenticated for this application data unit switching at least partially according to a specified mapping between the first clients and the second clients.

This embodiment is, for example, advantageous in order to ensure that only trustworthy clients use the at least one application data unit switching and are able to exchange application data units via the virtual connection application.

In exemplary embodiments of the first method according to the invention the server provides the at least one application data unit switching so that when a data packet having a control application data unit is received from one of the first clients at the server, the server sends a data packet with the control application data unit that the received data packet contains to the at least one of the second clients according to a mapping between the first clients and the second clients and/or a mapping of the control application data unit to at least one of the second clients, and/or that when a data packet with a response application data unit is received from one of the second clients at the server, the server sends a data packet with the response application data unit that the received data packet contains to at least one of the first clients according to a mapping between the first clients and the second clients and/or a mapping of the response application data unit to the at least one of the first clients.

As described above, the at least one application data unit switching provided by the server is, for example, established so that an application data unit received at the server (thus an application data unit that a received data packet contains) can be conveyed according to a mapping (e.g. a specified mapping) between the first clients and the second clients and/or a mapping of the application data unit to at least one of the first and/or second clients. Through such a mapping, for example, it can be determined which clients are intended to receive an application data unit and/or to which clients the server is intended to send (e.g. forward) an application data unit.

By way of example, an application data unit received at the server and/or a data packet received at the server, containing the application data unit, contains mapping information, wherein the mapping information can at least partially specify a mapping between the first clients and the second clients and/or a mapping of the application data unit to at least one of the first and/or second clients. For example, the mapping information contains a unique identifier (e.g. a username) for each client intended to receive the application data unit.

For example, the mapping is alternatively or additionally at least partially specified by mapping information stored in a database. For example, the mapping information is stored in a memory of the server. For example, the mapping information is stored in a memory outside of the server, which the server can access via a network connection (e.g. in a memory of a database server different from the server, providing a directory service).

For example, the first method according to the invention further comprises the checking, when a data packet having a control application data unit is received from one of the first clients at the server, whether the first client is authorised for the mapping (e.g. the mapping specified by the mapping information). For example, the access control means of the server are established to check, when a data packet with a control application data unit is received from one of the first clients at the server, whether the first client is authorised for the specified mapping. For example, a data packet with the control application data unit from the server that the received data packet contains, is only sent to the at least one of the second clients according to the specific mapping, if the first client is authorised for the specified mapping.

For example, the first clients are not authorised for each mapping. By way of example, an application data unit received at the server and/or a data packet received at the server, containing the application data unit, contains mapping information with a unique identifier (e.g. a user name) for a second client, intended to receive the application data unit, even though the first client is not authorised for a mapping to this second client. In this case, the server, for example, does not send a data packet with the control application data unit that the received data packet contains to this second client.

For example, the first method according to the invention further comprises the checking, when a data packet having a response application data unit from one of the second clients is received at the server, whether the second client is authorised for the mapping (e.g. the mapping specified by the mapping information). For example, the access control means of the server are established to check, when a data packet having a response application data unit from one of the second clients is received at the server, whether the second client is authorised for the specified mapping. For example, a data packet with the response application data unit from the server that the received data packet contains is only sent to at least one of the first clients according to the specified mapping, if the second client is authorised for the specified mapping.

For example, the authorisation information also comprises information on whether a client is authorised for a mapping. For example, the authorisation of the clients for a mapping is at least partially as a function of the respective users and/or operators of the clients and/or the respective chip cards connected to the second clients. The first clients are, by way of example, operated by chip card providers, such as, for example, a bank and serve, by way of example, for administration of the chip cards issued by the chip card provider. The second clients can, for example, be (directly) connected to chip cards, like, for example, a chip card terminal.

The authorisation of a first client for a mapping can at least partially, for example, be determined by the operator of the first client. The authorisation of a second client for a mapping can at least partially, for example, be determined by the chip card connected to the second client or the identity of the user (e.g. of the holder of the chip card) of the second clients. Through various mappings and authorisations for these it is thus, for example, possible for a number of chip card providers (e.g. banks and insurance companies, etc.) to use the application data unit switching provided by the server for transmitting application data units to and from a certain chip card (e.g. an electronic identity card or a combined debit and health insurance card of a certain user), or for a chip card provider (e.g. a bank) to use the application data unit switching provided by the server for transmitting application data units to and from a number of chip cards (e.g. all debit cards issued by the bank).

This embodiment is, for example, advantageous, in order to ensure, that only certain clients, which use the at least one application data unit switching, are also able to exchange application data units via the virtual connection. For example, only a first client, that is operated by a certain chip card provider such as, for example, a bank, can be authorised for mappings to second clients, connected to chip cards issued by the chip card provider, so that the server only conveys (e.g. sends) control application data units, received from this first client, to these second clients and conveys (e.g. sends) response application data units, which it receives from these second clients, only to this first client.

In exemplary embodiments of the invention the methods according to the invention further comprise accessing a chip card via the at least one application data unit switching provided by the server. For example, the methods according to the invention further comprise the accessing by at least one of the first clients of at least one chip card connected to the second clients via the application data unit switching.

This is, for example, advantageous, in order to allow remote access to a chip card or remote control of a chip card. In this way the need can be avoided to store information, that is necessary for accessing or controlling the chip card, such as chip card administration keys, chip card authentication information (e.g. passwords or PINs), keys for encrypting information for the chip cards and/or for decrypting information from the chip card and/or encryption certificates, on a local client (e.g. a second client), that can be directly connected to a chip card. Such a local client (e.g. a second client) is typically used by a number of users and is therefore particularly vulnerable to manipulations. Instead, such sensitive information can be stored on a remote client (e.g. a first client) and given special protection there.

Access to a chip card is intended, for example, to be understood as information being exchanged with the chip card. For example, a client accesses a chip card, when it sends a control application data unit to the chip card and/or receives a response application data unit from the chip card. A client sends, for example, a control application data unit to a chip card, when a chip card application, being executed by a processor of the client, generates a control application data unit for the chip card and causes the control application data unit to be sent to the chip card. A client receives, for example, a control application data unit on a chip card, when a chip card application, being executed by a processor of the client, receives a response application data unit from the chip card.

For example, the control application data unit contains an instruction for a chip card and/or the response application data unit contains a response from a chip card to an instruction. For example, the control application data unit contains an instruction for a chip card connected to at least one second client. For example, the response application data unit contains the response from the chip card connected to the at least one second client to the instruction.

In exemplary embodiments of the third method according to the invention, the method further comprises the connection of the second client with a chip card or the emulation of a connection with a chip card, and in exemplary embodiments of the first and second method according to the invention the second clients are connected to a chip card or emulate a connection with a chip card.

A chip card is, for example, a special plastic card with an integrated circuit (e.g. a chip), comprising at least one logic unit, one memory unit and/or one processor unit. A chip card is intended to be understood as a Smartcard or an Integrated Circuit Card (ICC). In particular, a chip card is intended to be understood as a chip card according to standard ISO 7816 and/or standard ISO 14443 and/or standard ISO 15693.

Connecting a second client to a chip card is intended, for example, to be understood as the second client being connected to a chip card. Preferably this is intended to be understood as the establishing of a logic connection from the second client to the chip card, via which the information and/or data (e.g. in the form of application data units) can be sent and received. A logic connection is, for example, established by the negotiation of communication parameters and/or sending and receiving information and/or data. For example, the second client can connect to a chip card, by negotiating communication parameters with the chip card and/or accessing the chip card. For example, the second client is connected to a chip card, when the chip card is located in a chip card access unit of the second client and/or when the second client is able to access the chip card via a chip card access unit of the second client. The connection between the second client and the chip card can be wired and/or wireless. An example of a wireless connection is a contactless connection such as a radio link, an inductive connection, a Near Field Communication (NFC), a Bluetooth connection and/or a Radio Frequency Identification connection (RFID). Standard ISO 14443 and standard ISO 15693 relate to contactless chip cards. For example, the connection between the second client and the chip card is a contactless connection according to standard ISO 14443 and/or standard ISO 15693. An example of a wired connection is a contact connection such as a connection between contacts arranged on the chip card and corresponding contacts of a chip card access unit. Standard ISO 7816 concerns chip cards with contacts. For example, the connection between the second client and the chip card is a contact connection according to standard ISO 7816.

Preferably the second clients are in each case directly connected to the chip card. A direct connection between a client and the chip card exists, for example, when no further data processing system is arranged between the client and the chip card. For example, a direct connection exists between a client and the chip card, when the client can access the chip card via a chip card access unit directly connected to the client.

For example, the second clients are established, in order in each case to be connected to a chip card. In particular, the second clients can be established in the form of software and/or hardware, in order to be connected to a chip card.

For example, the second clients in each case comprise a chip card access unit (e.g. a chip card access unit, a chip card reader unit and/or a chip card writing unit). By way of example, the second clients in each case comprise a chip card access unit according to standard ISO 7816 and/or standard ISO 14443 and/or standard ISO 15693. For example, the second clients can at least partially be chip card terminals such as authentication terminals or payment terminals, for example, payment terminals for making payments with debit cards and/or credit cards. A client is, for example, directly connected to a chip card access unit via an internal bus connection, a local wired connection such as a Universal Serial Bus connection (e.g. USB 1.1 or USB 2.0 or USB 3.0), a serial connection such as a RS 232-connection, an IEEE 1394 connection and/or a local wireless connection such as a Bluetooth connection.

For example, each of the second clients comprises a device driver program for the chip card access unit. The device driver program can be stored in a memory of the respective second client. By way of example, the device driver program for the chip card access unit comprises program instructions for controlling a communication with a chip card via the chip card access unit. For example, the device driver program for the chip card access unit provides other computer programs such as a chip card application or an agent program, that are executed by a processor of a respective second client, with an interface (e.g. a programming interface) for accessing a chip card via the chip card access unit, when the device driver program for the chip card access unit is executed on a processor of the second client. For example, the device driver program for the chip card access unit is part of the operating system layer of the second client, when it is executed on the processor of the second client, and provides other computer programs of the application layer of the second client with an interface (e.g. a programming interface) for accessing a chip card via the chip card access unit with application data units. For example, an application data unit is a data unit of the application layer.

Emulation of a connection with a chip card is intended, for example, to be understood as the second clients replicating a connection with a chip card by software without actually being connected to a chip card. For example, the second clients are established, in order to emulate a connection with a chip card. In particular the second clients can be established by software, in order to emulate a connection with a chip card.

For example, the third method according to the invention further comprises sending the control application data unit contained in the data packet received at the second client from the second client to the chip card connected to the second client, and/or receiving the response application data unit from the chip card connected to the second client at the second client. This is, for example, advantageous, in order to allow first clients, via the application data unit switching provided by the server and a second client, to access a chip card connected to the second client.

This is, for example, advantageous, to allow forwarding of application data units by the second client. For example, second clients are established, in order to forward application data units accordingly.

For example, the second clients in each case comprise computer programs (e.g. in each case agent programs) with program instructions, which cause the respective second client, to send a control application data unit contained in a data packet received at the second client to a chip card connected to the second client and/or to send a response application data unit received from the chip card connected to the second client in a data packet to the server, when the computer program is executed on a processor of the second client. For example, such computer programs are in each case stored in a memory of the second clients and are in each case executed by a processor of the second clients, in order to allow forwarding of application data units by the respective second client.

For example, the second method according to the invention comprises the generation of a control application data unit for at least one chip card connected to one of the second clients.

For example, the first clients are established, to generate control application data units for at least one chip card connected to one of the second clients.

For example, the first clients in each case comprise chip card applications with program instructions, that cause a first client to generate a control application data unit with instructions for a chip card and/or to obtain and interpret and/or further process response application data units from a chip card, when the chip card application is executed by a processor of the first client. For example, such chip card applications are in each case stored in a memory of the first clients and are in each case executed by a processor of the first clients.

For example, the first clients in each case comprise computer programs (e.g. client programs) with program instructions, that cause a first client to send a control application data unit generated by a chip card application with instructions for a chip card in a data packet to the server and/or to receive a response application data unit contained in a data packet and to forward the response application data unit contained therein to the chip card application or make it available to the chip card application for forwarding.

In exemplary embodiments of the invention the control application data unit is a Command Application Protocol Data Unit (Command-APDU) and the response application data unit a Response Application Protocol Data Unit (Response-APDU). An APDU is intended in particular to be understood as a data unit according to standard ISO 7816-4. An APDU serves, for example, for accessing a chip card application, which is executed by a processor of a data processing system, on a chip card.

In exemplary embodiments of the invention the receiving and sending of the data packets takes place via at least one network. For example, the data packets are transmitted via one or a plurality of networks. The transmission of the data packets can take place in either a connectionless or a connected manner. Examples of a network are, as described above, a Local Area Network (LAN) such as an Ethernet network or an IEEE 802 network, a Wide Area Network (WAN), a Global Area Network (GAN), a wireless network, a wired network, a mobile network, a telephone network and/or the Internet. For example, the server is at least partially connected via the Internet with the first clients and the second clients.

For example, the transmission of the data packets in the at least one network takes place according to a packet-switched transmission protocol such as TCP (Transmission Control Protocol) or UDP (User Datagram Protocol). By way of example, the control application data unit and/or the response application data unit are contained in the data packets in each case as user data.

For example, the transmission of the data packets in the at least one network takes place encrypted. For example, the data packets are transmitted according to one of the following encryption protocols: TLS (Transport Layer Security), SSL (Secure Sockets Layer) and/or Secure Messaging Protocol. This is, for example, advantageous, in order to protect the information contained in the data packets.

In exemplary embodiments of the first method according to the invention the method further comprises receiving status information from one of the second clients at the server, and sending the status information from the server to at least one of the first clients, and in exemplary embodiments of the second method according to the invention the method further comprises receiving the status information at the first client from the server, and in exemplary embodiments of the third method according to the invention the method further comprises generating the status information by the second client and sending the status information from the second client to the server.

For example, the at least one application data unit switching provided by the server is established so that, when a data packet with status information is received from one of the second clients at the server, the server sends a data packet with the status information that the received data packet contains to at least one of the first clients. For example, the first clients log on to receive the status information from one or a plurality of the second clients. For example, the logon information and/or the authorisation information contains corresponding information. By way of example, the server sends to all first clients logged on to receive status information of a second client, the status information received from the second client.

For example, the status information indicates if a second client is connected to a chip card or not. For example, the second clients generate each time corresponding status information, when they are connected to a chip card and/or when they are separated from a chip card. For example, the status information is contained in one or a plurality of data packets, which are sent from the second client to the server and from the server to the at least one first client (e.g. via respective network connections). For example, the status information from the second client to the server and/or from the server to the at least one first client is sent as a push notification.

This embodiment is, for example, advantageous in order to provide a notification return channel, via which the first clients can be informed of status changes of the second clients.

The exemplary embodiments of the invention described above in this application are intended to be understood as being disclosed in all combinations with each other.

Further advantageous exemplary embodiments of the invention are indicated in the following detailed description of a number of exemplary embodiments of the invention, in particular in combination with the figures.

The figures accompanying the application are, however, intended to be for clarification purposes only, and not to serve to determine the range of protection of the invention. The attached drawings are not to scale and are intended merely to reflect the general concept of the invention by way of example. In particular, features which are contained in the figures are in no way intended to be considered as essential components of the invention.

### BRIEF DESCRIPTION OF THE DRAWINGS

The figures show as follows:

FIG. 1 a block diagram of an exemplary embodiment of a data processing system;

FIG. 2 a block diagram of an exemplary embodiment of the system according to the invention;

FIG. 3 a flow diagram with steps of an exemplary embodiment of the first method according to the invention;

FIG. 4 a flow diagram with steps of an exemplary embodiment of the second method according to the invention;

FIG. 5 a flow diagram with steps of an exemplary embodiment of the third method according to the invention;

FIG. 6 a block diagram of an exemplary software architecture of the system according to the invention.

### DETAILED DESCRIPTION OF A NUMBER OF EXEMPLARY EMBODIMENTS OF THE INVENTION

The invention is described in the following using exemplary embodiments.

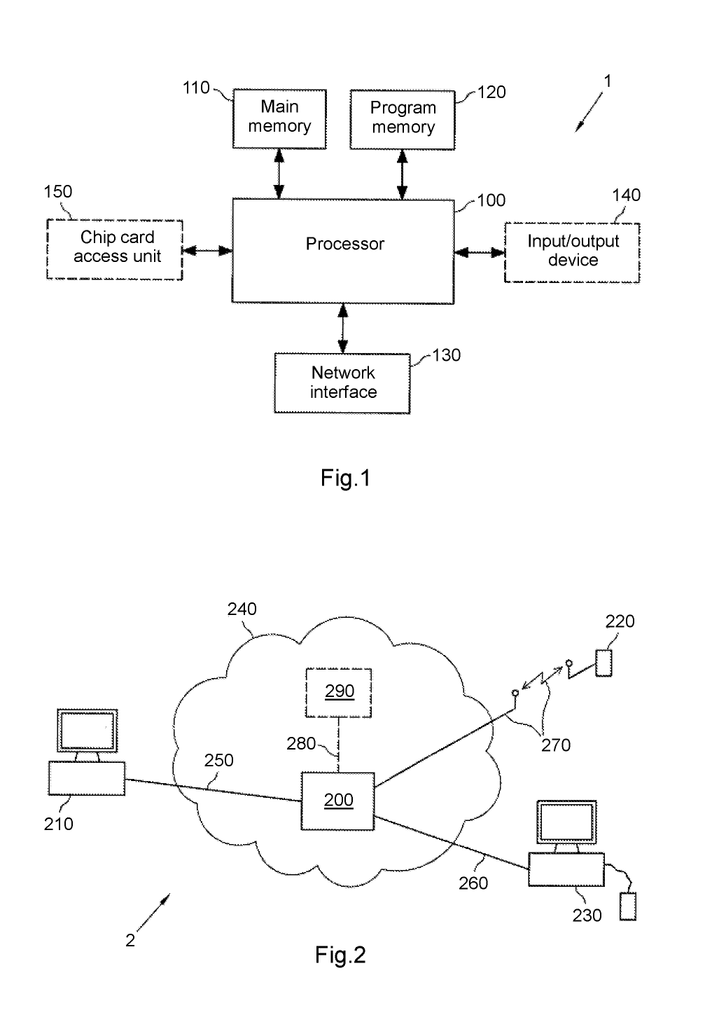

FIG. 1 shows a block diagram of an exemplary embodiment of a data processing system 1. Data processing system 1 shows an exemplary embodiment of a server according to the invention, a first client according to the invention and/or a second client according to the invention.

Data processing system 1 can, for example, be a computer, a desktop computer, a portable computer such as a laptop computer, a tablet computer, a personal digital assistant, a Smartphone, a thin client and/or a chip card terminal.

Processor 100 of the data processing system 1 is in particular in the form of a microprocessor, a microcontroller unit such as a microcontroller, a digital signal processor (DSP), an Application Specific Integrated Circuit (ASIC) or a Field Programmable Gate Array (FPGA).

Process 100 carries out program instructions, stored in program memory 120, and stores, for example, intermediate results or similar in main memory 110. For example, program memory 120 is a non-volatile memory such as a flash memory, a magnetic memory, an EEPROM memory (Electrically Erasable Programmable Read-Only Memory) and/or an optical memory. The main memory 110 is, for example, a volatile or non-volatile memory, in particular a Random Access Memory (RAM) such as a static RAM memory (SRAM), a dynamic RAM memory (DRAM), a Ferroelectric RAM memory (FeRAM) and/or a magnetic RAM memory (MRAM).

The program memory 120 is preferably a local data carrier with a fixed connection to the data processing system 1. Data carriers with a fixed connection to the data processing system 1 are, for example, hard discs, installed in the data processing system 1. Alternatively, the data carrier can, for example, also be a data carrier that is detachably connected to the data processing system 1 such as a memory stick, a removable storage device, a portable hard drive, a CD, a DVD and/or a diskette.

Program memory 120 contains the operating system of data processing system 1, which upon booting up of the data processing system 1 is at least partially loaded into main memory

110 and executed by the processor 100. In particular, upon booting up data processing system 1, at least part of the operating system core is loaded into the main memory 110 and executed by the processor 100. The operating system of data processing system 1 is preferably a Windows, UNIX, Linux, Android, Apple iOS and/or MAC operating system.

Only the operating system enables use of data processing system 1 for the data processing. It manages, for example, resources such as main memory 110 and program memory 120, network interface 130, input/output device 140 and chip card access unit 150, and provides, inter alia through programming interfaces, other programs with basic functions and controls the execution of programs.

Processor 100 controls the network interface 130, wherein control of the network interface 130 is, for example, enabled by a device driver program, which is part of the operating system core. Network interface 130 is, for example, a network card, a network module and/or a modem and is established, to establish a connection between the data processing system 1 and a network. Network interface 130 can, for example, receive data via the network and forward this to processor 100 and/or receive data from processor 100 and send it via the network. Examples of a network are a Local Area Network (LAN) such as an Ethernet network or an IEEE 802 network, a Wide Area Network (WAN), a Global Area Network (GAN), a wireless network, a wired network, a mobile network, a telephone network and/or the Internet.

Furthermore, processor 100 can control at least an optionally present input/output device 140, wherein the control of the optionally present input/output device 140, for example, is enabled by a device driver program, which is part of the operating system core. Input/output device 140 is, for example, a keyboard, a mouse, a display unit, a microphone, a touchscreen, a loudspeaker, a scanner, a disc drive and/or a camera. Input/output device 140 can, for example, receive inputs from a user and forward these to processor 100 and/or receive output information for the user from processor 100.

Furthermore, processor 100 can control at least one optionally present chip card access unit 150, wherein the control of the optionally present chip card access unit 150 is, for example, enabled by a device driver program, which is part of the operating system core. Chip card access unit 150 is, for example, a device for contactless or contact connection with a chip card. For example, chip card access unit 150 is a chip card access unit according to standard ISO 7816 and/or standard ISO 14443 and/or standard ISO 15693. For example, a second client according to the invention comprises chip card access unit 150. Chip card access unit 150 can be integrated into data processing system 1 (e.g. when data processing system 1 is a chip card terminal) or connected via an external data interface to data processing system 1. Data processing system 1 is directly connected to chip card access unit 150, for example, via a wired connection, a wireless connection, a USB connection (Universal Serial Bus, e.g. USB 1.1 or USB 2.0 or USB 3.0), a serial connection such as an RS 232 connection, an IEEE 1394 connection and/or a Bluetooth communication.

FIG. 2 shows a block diagram of an exemplary embodiment of the system 2 according to the invention. System 2 comprises a server 200, a client 210 and a chip card terminal 220 with an integrated chip card access unit and a computer 230 with an external chip card access unit. Server 200, client 210, chip card terminal 220 and computer 230 correspond to the data processing system 1 (see FIG. 1). System 200 can optionally comprise a directory service server 290.

Server 200 is an example of a server according to the invention. Server 200 is, for example, a server in the Internet 240, connected via its network interface with the Internet and offering an application data unit switching service. For example, on server 200 a computer program such as a server program is installed, that comprises program instructions, which cause server 200 to carry out the first method according to the invention, when the computer program is executed on the processor of the server 200. The computer program can be stored in the program memory of the server 200. Server 200 is, for example, a server of an application data unit switching service provider.

Client 210 is an example of a first client according to the invention. For example, on client 210 a computer program is installed, comprising program instructions, which cause client 210 to carry out the second method according to the invention, when the computer program is executed on the processor of the client 210. For example, this computer program comprises at least one chip card application and a client program. Client 210 is connected via network connection 250 with server 200. Network connection 250 is at least partially a connection via the Internet 240. Client 210 is, for example, operated by a chip card provider for administration of the chip cards issued by the chip card provider.

Chip card terminal 220 and computer 230 are examples of second clients according to the invention. For example, on chip card terminal 220 and computer 230 a computer program is installed, comprising program instructions, which cause chip card terminal 220 and computer 230 to carry out the third method according to the invention, when the computer program is executed on the processor of the chip card terminal 220 and the computer 230. For example, this computer program comprises at least one device driver program for the chip card access unit and one agent program. Computer 230 is connected via network connection 260 with server 200. Network connection 260 is at least partially a connection via the Internet 240. Chip card terminal 230 is connected via network connection 270 with server 200. Network connection 270 is at least partially a connection via the Internet 240 and partially a connection via a mobile network.

Directory service server 290 provides, for example, a directory service for administration of user information such as authorisations and/or logon information for the use of the application data unit switching of the server 200. Directory service server 290 is connected to server 200 via network connection 280. Network connection 280 is at least partially a connection via the Internet 240.

Network connections 250, 260, 270 and 280 are, for example, connection oriented network connections. For example, the data transmission takes place via network connections 250, 260, 270 and 280 according to a packet-switched transmission protocol such as TCP (Transmission Control Protocol) or UDP (User Datagram Protocol). For example, the data transmission take place via network connections 250, 260, 270 and 280 according to an encryption protocol such as TLS (Transport Layer Security), SSL (Secure Sockets Layer) and/or Secure Messaging Protocol.

System 2 can have further data processing systems, which similarly correspond to data processing system 1 and are connected via their respective network interface with the Internet 250.

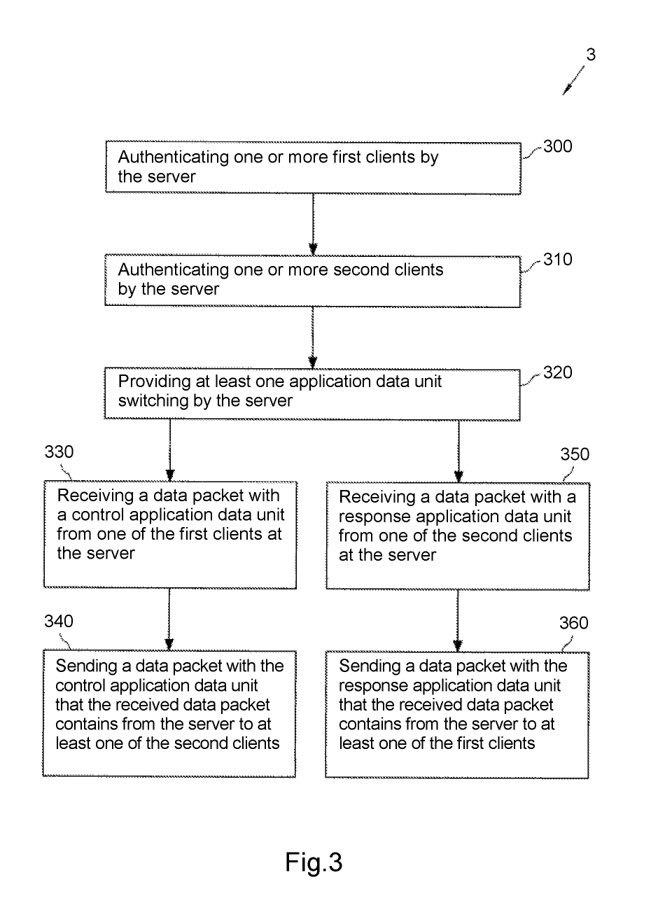

In the following, for the description of FIG. 3-5, it is by way of example assumed that client 210, via an application data unit switching provided by server 200, accesses a chip card connected to chip card terminal 220 and/or a chip card connected to computer 230. Accordingly, client 210 in the following is intended to be understood as an example of a first client according to the invention, the chip card terminal 220 and/or the computer 230 as an example of a second client according to the invention and server 200 as an example of a server according to the invention.

FIG. 3 is a flow diagram 3 with steps of an exemplary embodiment of the first method according to the invention, which take place on the server 200. For example, program instructions of a computer program such as a server program, executed by a processor of the server 200, cause the server 200 to carry out the steps of flow diagram 3.

In a step 300 server 200 authenticates client 210. By way of example, the server checks whether client 210 is authorised to use the application data unit switching provided by the server 200. For example, the server 200 receives via network connection 250 from client 210 logon information for a logon for the application data unit switching provided by the server 200.

For example, the server 200 has access to corresponding authorisation information. The authorisation information is, for example, customised for each first client and/or each second client. For example, the authorisation information comprises information corresponding to the logon information, such as a user name (e.g. an e-mail address, a customer number or a registration number), a password, an authentication feature, a biometric feature and/or a unique identifier of the respective client (e.g. a Media Access Control address or an International Mobile Subscriber Identity). The authorisation information can further comprise information on whether client 210 is authorised to use the application data unit switching. The authorisation information can, for example, be stored in the directory service of the server 290 and be queried there by the server 200.

In a step 310 server 200 authenticates chip card terminal 220 and computer 230. By way of example, the server 200 checks whether chip card terminal 220 and computer 230 are authorised to use the application data unit switching provided by the server 200. For example, the server 200 receives via the network connections 270 and 280 and 260 of chip card terminal 220 and computer 230 logon information for a logon for the application data unit switching provided by the server.

For example, the server 200 has access to corresponding authorisation information. The authorisation information is, as described above, for example, customised for each first client and/or each second client and comprises information corresponding to the logon information. The authorisation information can further comprise information on whether the chip card terminal 220 and the computer 230 are authorised to use the application data unit switching. The authorisation information can, for example, be stored in the directory service of the server 290 and queried there by the server 200.

In a step 320, the server 200 provides the application data unit switching for the client 210, the chip card terminal 220 and the computer 230. For example, the server 200 provides the application data unit switching only to clients authorised for it. For example, client 210 is operated by a bank for administration of the debit cards issued by the bank. Chip card terminal 220 is, for example, a payment terminal which, for example, is used for cashless payments with debit cards of the bank, and computer 230 is, for example, a computer which, for example, is used by a customer of the bank for home banking. For example, the server provides the application data unit switching for the conveying of application data units between the client 210 of the bank and all second clients connected to debit cards of the bank such as chip card terminal 220 and computer 230.

The server 200 provides the application data unit switching, for example, such that when a data packet having a control application data unit is received from client 210 via network connection 250 at the server 200, the server 200 sends a data packet with the control application data unit that the received data packet contains via network connection 270 to the chip card terminal 220 and/or via network connection 260 to the computer 230 (e.g. according to a specified mapping), and/or that, when a data packet having a response application data unit is received via network connection 270 from the chip card terminal 220 and/or via network connection 260 from the computer 230 at the server 200, the server 200 sends a data packet with the response application data unit that the received data packet contains via network connection 250 to client 210 (e.g. according to a specified mapping).

A control application data unit is, for example, an Application Protocol Data Unit (Command-APDU), and a response application data unit is, for example, a Response Application Protocol Data Unit (Response-APDU). An APDU is intended in particular to be understood as a data unit according to standard ISO 7816-4.

For example, the application data unit switching provided by the server 200 is established so that an application data unit received at the server 200 (thus an application data unit that a received data packet contains) is conveyed according to a specified mapping between the client 210 and the chip card terminal 220 and the computer 230. For example, a data packet received at the server 200 and/or the application data unit contained therein contains mapping information, specifying a mapping, on the client or clients to which the server is intended to send a data packet with the application data unit that the received data packet contains.

Optionally, the at least one application data unit switching provided by the server 200 is further established so that, when a data packet having status information is received from chip card terminal 220 or computer 230 at the server 200, the server 200 sends a data packet with the status information that the received data packet contains to client 210. For example, client 210 has logged on to server 200 to receive the status information from chip card terminal 220 and computer 230. For example, the logon information and/or the authorisation information contain corresponding information.

The subsequent optional steps 330 and 340 are, for example, always carried out, when the server 200 receives a control application data unit from the client 210. The following steps 330 and 340 can be carried out alternatively or additionally to steps 350 and 360.

In an optional step 330, the server 200 receives a data packet with a control application data unit from client 210. For example, the server 200 receives via network connection 250 a data packet with a control application data unit from client 210. For example, the data packet contains the control application data unit as user data.

Furthermore, the data packet can, for example, contain mapping information as user data. The mapping information can, for example, contain a unique identifier of the client, intended to receive the control application data unit. If, for example, the data packet received from client 210 contains such mapping information, the server 200 initially checks, for example, whether the client 210 is authorised for the mapping specified by the mapping information. For example, the authorisation information contains information on whether client 210 is authorised for a mapping.

In an optional step 340 the server 200 sends a data packet with the control application data unit that the received data packet contains from the server to the chip card terminal 220 and/or to the computer 230. For example, the server 200 sends a data packet with the control application data unit that the received data packet contains from the server via network connection 270 to the chip card terminal 220 and/or via network connection 260 to the computer 230. For example, the server 200 extracts the control application data unit from the received data packet and generates a new data packet (or a plurality of new data packets) with the control application data unit for sending to the chip card terminal 220 and/or the computer 230. For example, the newly generated data packet (or the newly generated data packets) contains or contain the control application data unit as user data. For example, the server sends the newly generated data packet (or the newly generated data packets) with the control application data unit according to the mapping specified by the mapping information to the chip card terminal 220 and/or the computer 230. For example, the server only sends the newly generated data packet (or the newly generated data packets) with the control application data unit according to the mapping specified by the mapping information to the chip card terminal 220 and/or the computer 230, if the client 210 is also authorised for the mapping.

The subsequent optional steps 350 and 360 are, for example, always carried out, when the server 200 receives a data packet with a response application data unit from the chip card terminal 220 or from the computer 230. The following steps 350 and 360 can be carried out alternatively or additionally to steps 330 and 340.

In an optional step 350 the server 200 receives a data packet with a response application data unit via network connection 270 from the chip card terminal 220 or via the network connection 260 from the computer 230.

For example, the server 200 receives a data packet with a response application data unit via network connection 270 from the chip card terminal 220 or via network connection 260 from the computer 230. For example, the data packet contains the response application data unit as user data.

Furthermore, the data packet can, for example, contain mapping information as user data. The mapping information can, for example, contain a unique identifier of the client, intended to receive the response application data unit. If, for example, a data packet received from the chip card terminal 220 contains such mapping information, the server initially checks, for example, whether the chip card terminal 220 is authorised for the mapping specified by the mapping information. For example, the authorisation information contains information on whether the chip card terminal 220 is authorised for a mapping.

In an optional step 360, the server 200 sends a data packet with the response application data unit that the received data packet contains to the client 210. For example, the server 200 sends a data packet with the response application data unit that the received data packet contains via network connection 250 to the client 210. For example, the server 200 extracts the response application data unit from the received data packet and generates a new data packet (or a plurality of new data packets) with the response application data unit for sending to the client 210. For example, the newly generated data packet contains the response application data unit as user data. For example, the server sends the newly generated data packet with the response application data unit according to the mapping specified by the mapping information to the client 210.

If, for example, a data packet received from the chip card terminal 220 contains such mapping information, the server only sends the newly generated data packet (or the newly generated data packets) with the response application data unit according to the mapping specified by the mapping information, if the chip card terminal 220 is also authorised for the mapping.

The server 200 can, apart from the application data unit switching described above for client 210, provide the chip card terminal 220 and the computer 230 with further application data unit switchings for further first and second clients. For these further application data unit switchings, the server 200 carries out the steps 300 to 370 with the further first and second clients. The application data unit switching of the server can allow a 1:1 mapping (one first client to one second client), a 1:n mapping (one first client to all second clients), an n:1 mapping (all first clients to one second client) and an n:n-mapping (all first clients to all second clients).

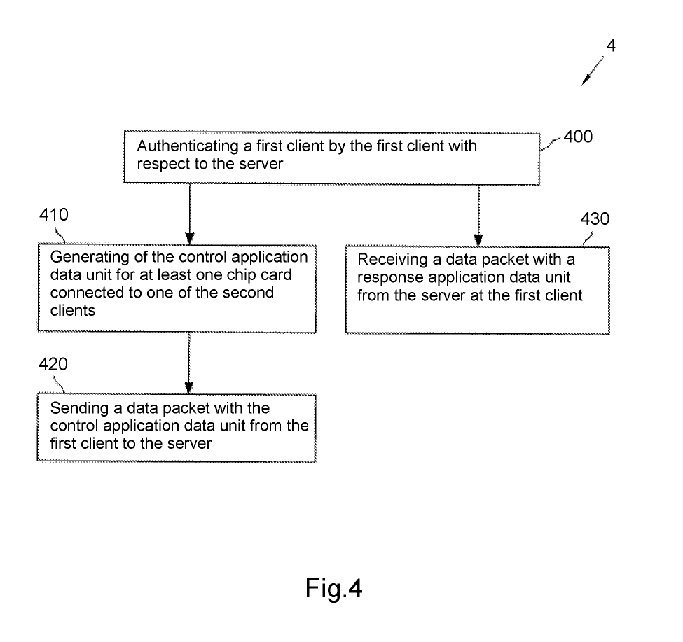

FIG. 4 is a flow diagram 4 with steps of an exemplary embodiment of the second method according to the invention, which take place on the client 210. For example, program instructions of a computer program such as a chip card application (e.g. step 410) and a client program (e.g. steps 400 and 420 to 430), executed by a processor of the client 210, cause the client 210 to carry out the steps of the flow diagram. For example, the client program provides an interface for accessing a chip card via the application data unit switching provided by the server 200. For example, the interface is a virtual device driver for a chip card access unit (e.g. a virtual PC/SC device driver) and/or a programming interface (API, Application Programming Interface). For example, the chip card application uses the interface, to access one or a plurality of chip cards via the application data unit switching provided by the server 200.

In a step 400 client 210 authenticates itself with respect to the server 200. By way of example, client 210 logs on to server 200, in order to use the application data unit switching provided by the server 200. For example, only clients logged on to the server 200 may use the application data unit switching. For example, client 210 sends logon information to the server. For example, client 210 sends logon information via network connection 250 to the server 200.

The logon information is, for example, customised for client 210 or the operator of client 210. For example, the logon information comprises a user name (e.g. an e-mail address, a customer number or a registration number), a password, an authentication feature, a biometric feature and/or a unique identifier of the respective client (e.g. a Media Access Control address or an International Mobile Subscriber Identity).

The logon information can at least partially be input by a user on an input/output device of the client 210 and/or at least partially read-in by an input/output device and/or a chip card access unit of the client 210. For example, a user can in each case enter a user name and a password at the client 210 as logon information. For example, an authentication feature can be read in from a security token such as a chip card and/or a biometric feature of a user as logon information by the client 210.

Once authentication of the client 210 by the server has taken place (see step 300) the client 210 can, for example, use the application data unit switching provided by the server 200 (see step 330), in order to access a chip card connected to the chip card terminal 220 and/or the computer 230.

The subsequent optional steps 410 and 420 are, for example, always carried out, when the client 210 generates a control application data unit for a chip card connected to the chip card terminal 220 and/or the computer 230. The following steps 410 and 420 can be carried out alternatively or additionally to step 430.

In an optional step 410 the client 210 generates a control application data unit for at least one chip card connected to the chip card terminal 220 and/or the computer 230. The control application data unit contains, for example, an instruction for the chip card.

Furthermore, the client 210 can, for example, generate mapping information with a unique identifier for each client, intended to receive the control application data unit.

In an optional step 420, the client 210 sends a data packet with the generated control application data unit to the server 200. For example, the client 210 sends a data packet with the generated control application data unit via network connection 250 to the server 200. For example, the client 210 generates a new data packet with the control application data unit for sending to the server 200. For example, the newly generated data packet contains the control application data unit as user data. For example, the newly generated data packet further contains the mapping information.

The following step 430 is, for example, always carried out, when the client 210 receives a response application data unit from the server 200. The following step 430 can be carried out alternatively or additional to steps 410 and 420.

In an optional step 430, the client 210 receives a data packet with a response application data unit from the server 200. For example, the response application data unit is contained in the data packet as user data. For example, the response application data unit was generated by a chip card connected to the chip card terminal 220 and/or the computer 230. For example, the client 210 extracts the response application data unit from the received data packet, so that the response application data unit can be further processed by a chip card application executed by a processor of the client 210.

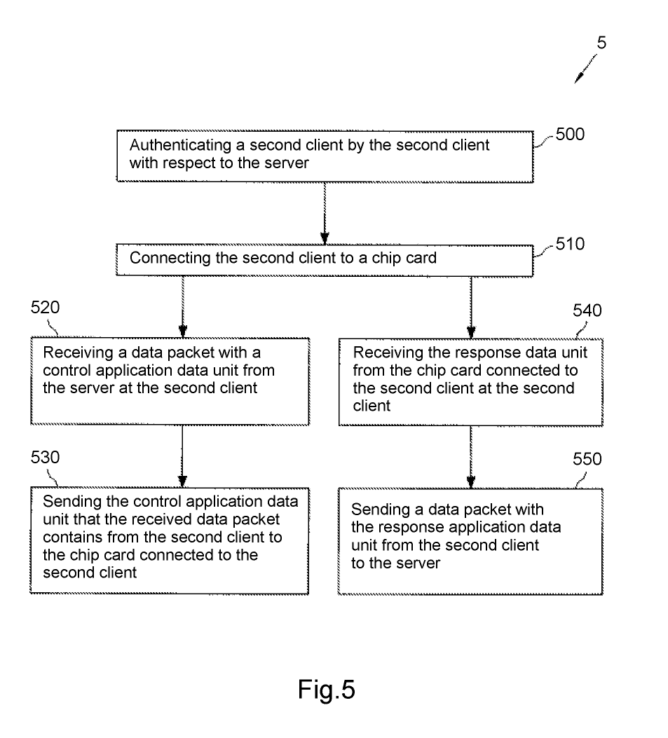

FIG. 5 is a flow diagram 5 with steps of an exemplary embodiment of the third method according to the invention, which take place on the chip card terminal 220 or the computer 230. In the following, merely by way of example, reference is always made to computer 230. For example, program instructions of a computer program such as a device driver program for a chip card access unit (e.g. steps 510, 530 and 540) and an agent program (e.g. steps 500, 520 and 550), executed by a processor of the computer 230, cause the computer 230 to carry out the steps of flow diagram 5. For example, the agent program interacts with the device driver program for the chip card access unit, in order to allow access to a chip card connected to the computer 230 via the application data unit switching provided by the server 200. For example, the device driver program for the chip card access unit provides other computer programs such as the agent program with an interface (e.g. a program interface) for accessing a chip card via the chip card access unit.

In a step 500, computer 230 authenticates itself with respect to the server 200. By way of example, computer 230 logs on to the server 200, in order to use the application data unit switching provided by the server 200. For example, only clients logged on to the server 200 may use the application data unit switching. For example, the computer 230 sends logon information to the server. For example, computer 230 sends logon information via network connection 260 to the server 200.

The logon information is, for example, customised for computer 230 or the user of computer 230. For example, the logon information comprises a user name (e.g. an e-mail address, a customer number or a registration number), a password, an authentication feature, a biometric feature and/or a unique identifier of the respective client (e.g. a Media Access Control address or an International Mobile Subscriber Identity).

The logon information can at least partially be entered by a user on an input/output device of the computer 230 and/or at least partially read in by an input/output device and/or a chip card access unit of the computer 230. For example, a user can in each case enter a user name and a password on the computer 230 as logon information. For example, an authentication feature of a security token such as a chip card and/or a biometric feature of a user can be read in by the computer 230 as logon information.

Once authentication of the computer 230 by the server has taken place (see step 300), first clients logged on to the server 200 for the application data unit switching provided by the server 200 (e.g. first clients authenticated by the server 200 for the application data unit switching provided by the server 200), can, for example, use the application data unit switching provided by the server 200, to access a chip card connected to the computer 230.

In an optional step 510 computer 230 connects to a chip card. The optional step 510 can, for example, also be carried out before step 500, for example, when for the authentication of the computer 230 with respect to the server 200 an authentication feature stored on the chip card has to be read in as logon information.

Connection of the computer 230 with the chip card is intended, for example, to be understood as establishing a logical connection from the computer 230 to the chip card, via which data and information (e.g. in the form of application data units) can be sent and received. A logical connection is, for example, established by the negotiation of communication parameters and/or sending and receiving data and/or information. For example, the computer 230 can connect to a chip card, by negotiating communication parameters with the chip card and/or accessing the chip card. For example, computer 230 is connected to the chip card, as soon as the chip card is located in the chip card access unit of the computers 230 and computer 230 can access the chip card.

The connection of the computer 230 to the chip card can be either wireless or wired. Preferably the computer 230 is directly connected to the chip card.

As soon as the computer 230 is connected to a chip card, it generates, for example, optionally corresponding status information and sends this status information (e.g. via network connection 260) to the server 200.

The subsequent optional steps 520 and 530 are, for example, always carried out when the computer 230 receives a data packet with a control application data unit from the server 200. The following steps 520 and 530 can be carried out alternatively or additionally to steps 540 and 550.

In an optional step 520, computer 230 receives a data packet with a control application data unit from the server 200. For example, computer 230 receives a data packet with a control application data unit via network connection 260 from the server 200. For example, the control application data unit was generated by the client 210. For example, the data packet contains the control application data unit as user data.

In an optional step 530, computer 230 sends the control application data unit that the received data packet contains to the chip card connected to the computer 230. For example, the computer 230 extracts the control application data unit from the received data packet. For example, the computer 230 sends the control application data unit that the received data packet contains via the logical connection to the chip card connected to the computer 230.

The subsequent optional steps 540 and 550 are, for example, always carried out, when the computer 230 receives a response application data unit from the chip card connected to the computer 230. The following steps 540 and 550 can be carried out alternatively or additionally to steps 520 and 530.

In an optional step 540, computer 230 receives a response application data unit from the chip card connected with the chip card terminal. For example, computer 230 receives the response application data unit via the logical connection from the chip card connected to the chip card terminal. For example, the response application data unit was generated by the chip card.

Furthermore, the client 210 can, for example, generate mapping information with a unique identifier for each client, intended to receive the response application data unit.

In an optional step 550, computer 230 sends a data packet with the response application data unit to the server 200. For example, computer 230 sends a data packet with the response application data unit via network connection 260 to the server 200. For example, the computer 230 generates a data packet with the response application data unit for sending to the server 200. For example, the newly generated data packet further contains the mapping information.

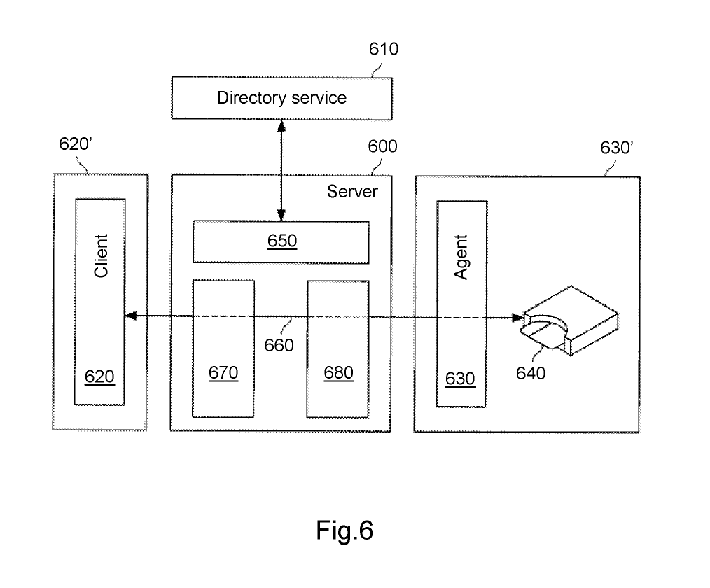

FIG. 6 shows a block diagram of an exemplary software architecture of the system according to the invention. FIG. 6 shows merely by way of example server 600 as a server according to the invention, directory service server 610, client 620 and agent 630.

Agent 630 is, for example, an agent program, executed by a processor of a second client 630′ according to the invention. Agent 630 is, for example, an application which communicates with a device driver for a chip card (e.g. a device driver for a chip card access unit and/or a PC/SC device driver), which is part of the operating system or the operating system layer of the client, and with server 600. For example, agent 630 receives a control application data unit (e.g. a Command-APDU) from the server 600 and forwards it to a chip card 640 (e.g. a Smartcard) connected to the client 630′. The response application data unit (e.g. a Response-APDU) from the chip card 640 is fed back to the server 600.

Client 620 is, for example, a client program, which is executed by a processor of a first client 620′ according to the invention. Client 620 is, for example, an application, which communicates with the server 600 via a network connection. Client 620 sends, for example, control application data units (e.g. Command-APDUs) to the server 600 and receives response application data units (e.g. Response-APDUs) from server 600.

The server 600 manages, for example, the connection between an agent such as agent 630 and a client such as client 620. It forwards, for example, an application data unit (e.g. a Command-APDU) sent by client 620 to the agent 630 and receives an application data unit (e.g. a Response-APDU) as a response from the agent 630 and feeds it back to the client 620.

In this way client 620 can send a control application data unit to a chip card 600 and receive a response from this chip card, irrespective of where the chip card 600 is and how and with which host the chip card is connected. Thus a virtual connection 660 is established between client 620 and chip card 600.

Client 620 can thus modify the contents of chip card 640 remotely and use a cryptographic function of the chip card 640 remotely. The advantage over other solutions is that here, inter alia, merely application data units are exchanged via a network (or virtual connection 660).

In order to protect the application data units exchanged via the network or the virtual connection, the Secure Messaging Protocol can, for example, be used. The key (e.g. private key for chip card administration of the chip card 640, user name, passwords, Personal Identification Numbers, etc.) do not leave the client 620. Sensitive information can thus be stored in the protected environment of the client 620. In this way secure chip administration by the client 620 can take place, irrespective of the environment of the agent 630.

Each client and each agent must, for example, authenticate itself with respect to the server 600, before it can communicate. This guarantees the identity of each client and each agent.

The server 600 can also manage the connection between clients and agents (session management). This means that, for example, only an authorised client may access a certain agent. For example, 1:n, n:1 or n:n client:agent mappings are supported. For example, chip card 640 can be used with various clients 620 (e.g. by clients 620 of various chip card issuers) and/or client 620 can be used by various chip cards 640.

The identity management and session management by the server 600 are, for example, both implemented by the use of an access conditions management interface 650, which is connected with the directory service 610. For connection with the client 620 the server 600, for example, has a client interface 670. For connecting with the agent 630 the server 600, for example, has an agent interface 680. For example, the access conditions management interface 650, the client interface 670 and the agent interface 680 are provided by a server program executed by a processor of the server 600.

In some cases, a direct connection between client 620 and agent 630, for example, due to a network configuration or a Firewall, is prevented. In such cases application data units can nevertheless be transmitted via the virtual connection 660, since both client 620 and agent 630 are clients of the server 600. Provided that both client 620 and agent 630 are able to connect with server 600, application data units can be transmitted between client 620 and agent 630 via the virtual connection.

The sequence of the individual method steps in the individual flow diagrams is not mandatory, and unless otherwise stated alternative sequences of the method steps are conceivable. The method steps can be implemented in various ways, thus implementation by software (by program instructions), hardware or a combination of the two are conceivable for implementing the method steps.

The exemplary embodiments of the invention described in this specification are intended to also be disclosed in all combinations with each other. In particular also, the description of a feature which an embodiment comprises—unless expressly stated to the contrary—shall not be understood here that the feature is indispensable or essential to the function of the embodiment. The sequence of the method steps described in this specification in the individual flow diagrams is not essential, and alternative sequences of the method steps are conceivable. The method steps can be implemented in various ways, thus implementation by software (by program instructions), hardware or a combination of the two are conceivable for implementing the method steps. Terms such as “comprise”, “have”, “include”, “contain” and so on, used in the claims shall not exclude further elements or steps. The wording “at least partially” covers both the case of “partially” and the case of “completely”. The wording “and/or” covers both the case of “and” and the case of “or”. A multiplicity of units, persons, or similar shall mean, in connection with this specification a plurality of units, persons or similar. The use of the indefinite article shall not exclude a multiplicity. A single device can perform the functions of a plurality of units or devices mentioned in the claims. Reference numerals mentioned in the claims shall not be deemed as restrictions on the means and steps used.

1. A method comprising:
authenticating one or more first clients by a server,
authenticating one or more second clients by the server, and
providing at least one application data unit switching by the server such that, when a data packet having a control application data unit is received from one of the first clients at the server, the server sends a data packet having the control application data unit that the received data packet contains to at least one of the second clients according to a mapping between the one or more first clients and the one or more second clients, and/or that, when a data packet having a response application data unit is received from one of the second clients at the server, the server sends a data packet having the response application data unit that the received data packet contains to at least one of the first clients according to a mapping between the one or more first clients and the one or more second clients, wherein the mapping is a mapping between one first client and a plurality of second clients, a mapping between a plurality of first clients and one second client and/or a mapping between a plurality of first clients and a plurality of second clients, wherein the mapping determines to which clients the server is intended to send a data packet with an application data unit.

2. The method according to claim 1, further comprising:
receiving a data packet with a control application data unit from one of the first clients at the server, and
sending a data packet with the control application data unit that the received data packet contains from the server to at least one of the second clients.

3. The method according to claim 2, wherein the server sends the data packet according to the mapping to the at least one of the second clients.

4. The method according to claim 1, further comprising:
receiving a data packet with a response application data unit from one of the second clients at the server, and
sending a data packet with the response application data unit that the received data packet contains from the server to at least one of the first clients.

5. A server comprising at least one processor and at least one memory with program instructions, wherein the at least one memory and the program instructions are configured, together with the at least one processor, to cause the server to:
authenticate one or more first clients by a server,
authenticate one or more second clients by the server, and
provide at least one application data unit switching by the server such that, when a data packet having a control application data unit is received from one of the first clients at the server, the server sends a data packet having the control application data unit that the received data packet contains to at least one of the second clients according to a mapping between the one or more first clients and the one or more second clients, and/or that, when a data packet having a response application data unit is received from one of the second clients at the server, the server sends a data packet having the response application data unit that the received data packet contains to at least one of the first clients according to a mapping between the one or more first clients and the one or more second clients, wherein the mapping is a mapping between one first client and a plurality of second clients, a mapping between a plurality of first clients and one second client and/or a mapping between a plurality of first clients and a plurality of second clients, wherein the mapping determines to which clients the server is intended to send a data packet with an application data unit.

6. The server according to claim 5, wherein the at least one memory and the program instructions are further configured, together with the at least one processor, to cause the server to:
receive a data packet with a control application data unit from one of the first clients at the server, and
send a data packet with the control application data unit that the received data packet contains from the server to at least one of the second clients.

7. The server according to claim 6, wherein the server is caused to send the data packet according to the mapping to the at least one of the second clients.

8. The server according to claim 5, wherein the at least one memory and the program instructions are further configured, together with the at least one processor, to cause the server to:
receive a data packet with a response application data unit from one of the second clients at the server, and
send a data packet with the response application data unit that the received data packet contains from the server to at least one of the first clients.

9. The server according to claim 8, wherein the server is caused to send the data packet according to the mapping to the at least one of the first clients.

10. The server according to claim 5, wherein the first clients and the second clients are authenticated by the server for the at least one application data unit switching.

11. The server according to claim 5, wherein the at least one memory and the program instructions are further configured, together with the at least one processor, to cause the server to:
check, when a data packet having a control application data unit is received from one of the first clients at the server, whether the first client is authorised for the mapping, and/or
check, when a data packet having a response application data unit is received from one of the second clients at the server, whether the second client is authorised for the mapping.

12. The server according to claim 5, wherein the at least one memory and the program instructions are further configured, together with the at least one processor, to cause the server to:
access a chip card via the application data unit switching.

13. The server according to claim 5, wherein the control application data unit contains an instruction for a chip card.

14. The server according to claim 5, wherein the response application data unit contains a response from a chip card to an instruction.

15. The server according to claim 5, wherein the control application data unit is a Command Application Protocol Data Unit, Command-APDU, and wherein the response application data unit is a Response Application Protocol Data Unit, Response-APDU.

16. The server according to claim 5, wherein the receiving and sending of the data packets take place via at least one network.

17. The server according to claim 16, wherein the transmission of the data packets takes place in the at least one network according to a packet-switched transport protocol.

18. The server according to claim 17, wherein the transmission of the data packets in the at least one network takes place encrypted.

19. A tangible machine-readable storage medium containing a computer program, comprising:
program instructions that cause a data processing system to carry out the following steps, when the computer program is executed on a processor of the data processing system:
authenticating one or more first clients,
authenticating one or more second clients, and
providing at least one application data unit switching such that, when a data packet having a control application data unit is received from one of the first clients at the data processing system, the data processing system sends a data packet having the control application data unit that the received data packet contains to at least one of the second clients according to a mapping between the one or more first clients and the one or more second clients, and/or that, when a data packet having a response application data unit is received from one of the second clients at the data processing system, the data processing system sends a data packet having the response application data unit that the received data packet contains to at least one of the first clients according to a mapping between the one or more first clients and the one or more second clients, wherein the mapping is a mapping between one first client and a plurality of second clients, a mapping between a plurality of first clients and one second client and/or a mapping between a plurality of first clients and a plurality of second clients, wherein the mapping determines to which clients the data processing system is intended to send a data packet with an application data unit.

20. A system for providing a virtual connection for transmitting application data units, which system comprises:
the server according to claim 5,
a first client, and
a second client.
